(19) United States
(12) Patent Application Publication
(10) Pub. No.: US 2006/0106687 A1
(43) Pub. Date: May 18, 2006

(54) Modified cash-basis specifications and grid

(75) Inventors: Arun Lal, Kirkland, WA (US); Donna Lynn Daem, Bellevue, WA (US); Hans Jorgen Gron, Kirkland, WA (US); Raghu R. Panganamamula, Hyderabad (IN); Sumeet U. Shrivastava, Kirkland, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 10/988,753

(22) Filed: Nov. 15, 2004

(51) Int. Cl. G07F 19/00; G07B 17/00

(52) U.S. Cl. 705/30

(57) ABSTRACT

A method of automatically converting from accrual based accounting to cash basis accounting using a computer is disclosed. The method may include reviewing an entry in a general ledger, determining whether an entry in the general ledger is for a transaction between general ledger accounts that are treated differently in accrual based accounting and cash based accounting, for an entry determined to be between general ledger accounts that are treated differently in accrual based accounting and cash based accounting, calculating a modifying entry to convert the entry from accrual basis accounting to cash basis accounting, applying the calculated modification entry to the entry, and creating a modified balance sheet and modified income statement based on the modified entry.

### BACKGROUND

Accounting is the system to track and review the financial performance of a business or entity. Double entry accounting provides that every entry into the accounting system requires two entries in different accounts that offset each other, thereby keeping the books in balance. One basis for accounting is a cash basis and a second basis is an accrual basis. Using a cash basis, finds are recognized when the funds are actually received and expenses are recognized when payments are actually made. Using an accrual basis, finds are recognized once an item or service is sold, creating a receivable that will be received in the future and expenses are recognized when they are incurred, creating a payable that will be paid at a point in the future. Modern tax code allows certain businesses to use cash basis accounting and other businesses to use accrual based accounting. The use of either accrual or cash basis accounting can have desirable or undesirable tax consequences as the reportable income can change depending on the basis selected. In addition, certain creditors may desire to see financial statements using cash basis accounting and other creditors may desire to see financial performance using accrual based accounting. However, accurately switching the basis of accounting and determining the effects of switching the basis of accounting for a given company has been a challenging task, but a task that has a potential payoff in lower reportable income and lower taxes to be paid.

### SUMMARY

A method of automatically converting from accrual based accounting to cash basis accounting using a computer is disclosed. The method may include reviewing an entry in a general ledger, determining whether an entry in the general ledger is for a transaction between general ledger accounts that are treated differently in accrual based accounting and cash based accounting, for an entry determined to be between general ledger accounts that are treated differently in accrual based accounting and cash based accounting, calculating a modifying entry to convert the entry from accrual basis accounting to cash basis accounting, applying the calculated modification entry to the entry, and creating a modified balance sheet and modified income statement based on the modified entry.

Additionally, the method may include creating a table of the entries that were modified. The method may also include placing in a phantom income account payments from customers that have not yet been applied to an invoice such that the payments are included in the modified balance sheet and modified income statement, placing in a phantom expense account payments to vendors that have not yet been applied to a bill such that the expenses are included in the modified balance sheet and modified income statement, displaying in the sales tax payable account the opening balance, sales tax paid on paid or partially paid invoices and payments to tax vendors so long as the amounts had at least one posting to a cash or bank account, allowing a user to select, using a drop down selection box, to view financial statements as one of cash basis statements and accrual basis statements, allowing a user to select, using a drop down selection box, to view financial statements as one of cash basis statements and accrual basis statements and allowing the user to switch between the cash basis statements and the accrual basis statements, allowing a user to create a statement that highlights the differences between cash basis accounting and accrual based accounting for a particular entity, and allowing a user to view financial statements as one of cash basis statements and accrual basis statements and allowing the user to switch between the cash basis statements and the accrual basis statements by storing the calculated changes in a temporary location without modifying the underlying entries.

Also disclosed is a memory having a computer program stored therein, said computer program being capable of being used in connection with a computing apparatus where the memory may have a memory portion physically configured in accordance with computer program instructions that would cause the computing apparatus to review postings in a general ledger, determining whether the entry in the general ledge is for a transaction between general ledger accounts that are treated differently in accrual based accounting and cash basis accounting, for entries determined to be between general ledger accounts that are treated differently in accrual based accounting and cash basis accounting, determining a modifying entry to the entry to convert the entry from accrual basis accounting to cash basis accounting, modifying the amount of the entries based on the determined modified entry and create a modified balance sheet and modified income statement based on the reversed payable and accrual entries. The modifying entry may be based on the percentage of a payment that has been received or based on the percentage of a payment that has been made.

The computer program instructions may also cause the computing apparatus to create a table of the entries that were modified, place in a phantom income account payments from customers that have not yet been applied to an invoice such that the payments are included in the modified balance sheet and modified income statement, place in a phantom expense account payments to vendors that have not yet been applied to a bill such that the expenses are included in the modified balance sheet and modified income statement, display in the sales tax payable account the opening balance, sales tax paid on paid or partially paid invoices and payments to tax vendors so long as the amounts had at least one posting to a cash or bank account, to allow a user to select, using a drop down selection box, to view financial statements as one of cash basis statements and accrual basis statements, allow a user to select, using a drop down selection box, to view financial statements as one of cash basis statements and accrual basis statements and allowing the user to switch between the cash basis statements and the accrual basis statements, allow a user to create a statement that highlights the differences between cash basis accounting and accrual based accounting for a particular entity, and allow a user to view financial statements as one of cash basis statements and accrual basis statements and allowing the user to switch between the cash basis statements and the accrual basis statements by storing the calculated changes in a temporary location without modifying the underlying entries.

Additionally disclosed is a computing apparatus, that may include a display unit that is capable of generating video images, an input device, a processing apparatus operatively coupled to said display unit and said input device, said processing apparatus may include a processor and a memory operatively coupled to said processor, a network interface connected to a network and to the processing apparatus. The processing apparatus may be programmed to review postings in a general ledger, determining whether the entry in the general ledge is for a transaction between general ledger accounts that are treated differently in accrual based accounting and cash basis accounting, for entries determined to be between general ledger accounts that are treated differently in accrual based accounting and cash basis accounting, determining a modifying entry to the entry to convert the entry from accrual basis accounting to cash basis accounting, modifying the amount of the entries based on the determined modified entry and create a modified balance sheet and modified income statement based on the reversed payable and accrual entries. The modifying entry may be based on the percentage of a payment that has been received or based on the percentage of a payment that has been made.

The processing apparatus may also be programmed to creating a table of the entries that were modified, place in a phantom income account payments from customers that have not yet been applied to an invoice such that the payments are included in the modified balance sheet and modified income statement, place in a phantom expense account payments to vendors that have not yet been applied to a bill such that the expenses are included in the modified balance sheet and modified income statement, display in the sales tax payable account the opening balance, sales tax paid on paid or partially paid invoices and payments to tax vendors so long as the amounts had at least one posting to a cash or bank account, allow a user to select, using a drop down selection box, to view financial statements as one of cash basis statements and accrual basis statements, allow a user to select, using a drop down selection box, to view financial statements as one of cash basis statements and accrual basis statements and allowing the user to switch between the cash basis statements and the accrual basis statements, allow a user to create a statement that highlights the differences between cash basis accounting and accrual based accounting for a particular entity and view financial statements as one of cash basis statements and accrual basis statements and allowing the user to switch between the cash basis statements and the accrual basis statements by storing the calculated changes in a temporary location without modifying the underlying entries.

### BRIEF DESCRIPTION OF THE DRAWINGS

FIG. 1 is a block diagram of an embodiment of a computing apparatus system in accordance with the claims;

FIG. 2 is a block diagram of a method in accordance with the claims;

FIG. 3 is an illustration of a table of transactions between accounts that will be reviewed in accordance with the claims;

FIGS. 4a and 4b are illustration of a general ledger in accordance with the claims;

FIG. 5 is an illustration of profit and loss statement in accordance with the claims;

FIG. 6 is an illustration of a balance sheet in accordance with the claims;

FIG. 7 is an illustration of a sales by item listing in accordance with the claims;

FIG. 8 is an illustration of a sales by customer listing in accordance with the claims;

FIG. 9 is an illustration of a phantom income listing in accordance with the claims;

FIG. 10 is an illustration of a balance sheet comparing cash basis versus accrual basis accounting for a given company in accordance with the claims;

FIG. 11 is an illustration of a balance sheet comparing cash basis versus accrual basis accounting for a given company in accordance with the claims; and

FIG. 12 is an illustration of a income statement comparing cash basis versus accrual basis accounting for a given company in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

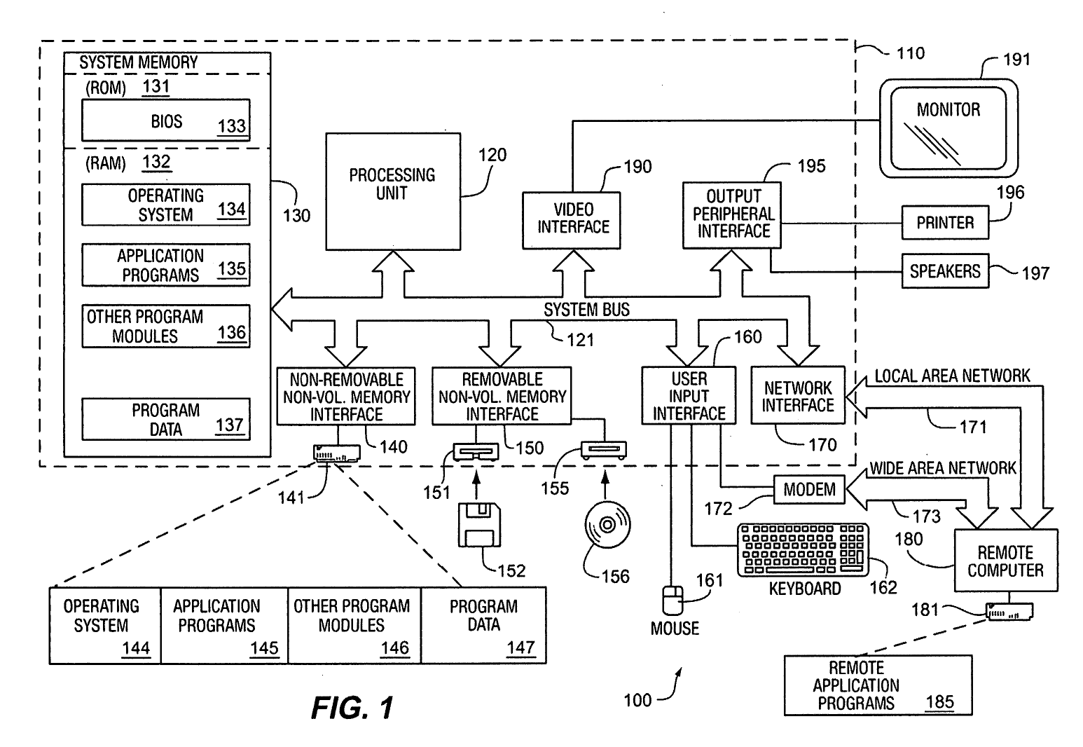

FIG. 1 illustrates an example of a suitable computing system environment 100 on which the claimed method and programmed memory and apparatus may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The claimed methods, programmed memory and apparatus are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The claimed methods, apparatus and programmed memory may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the claimed methods, apparatus and programmed memory includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### ACCOUNTING SYSTEMS AND METHODS

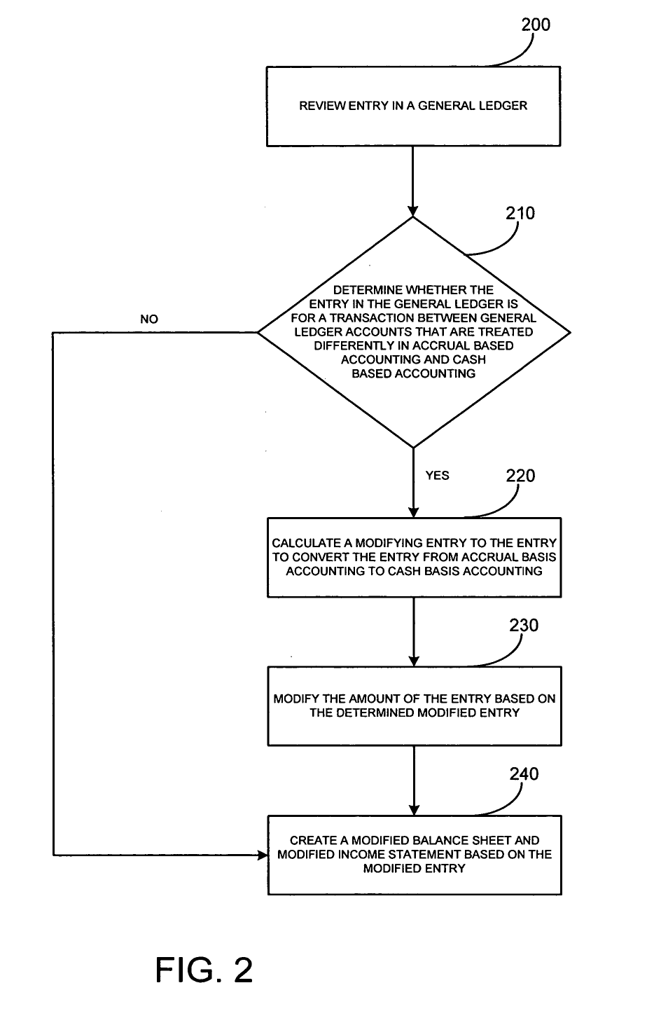

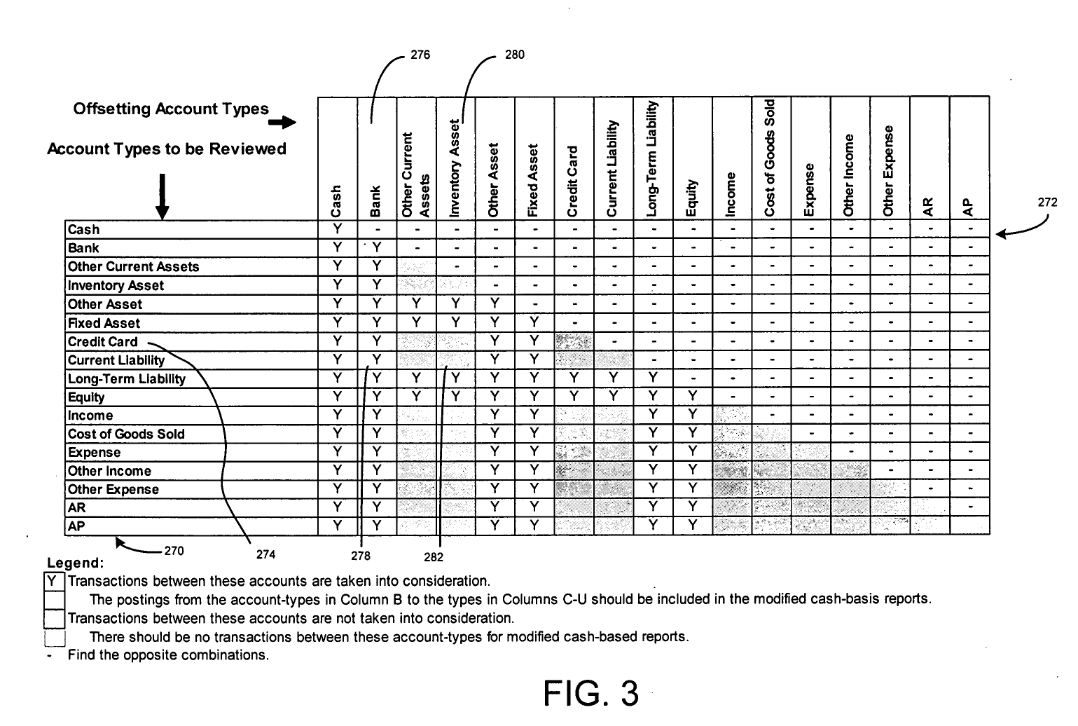

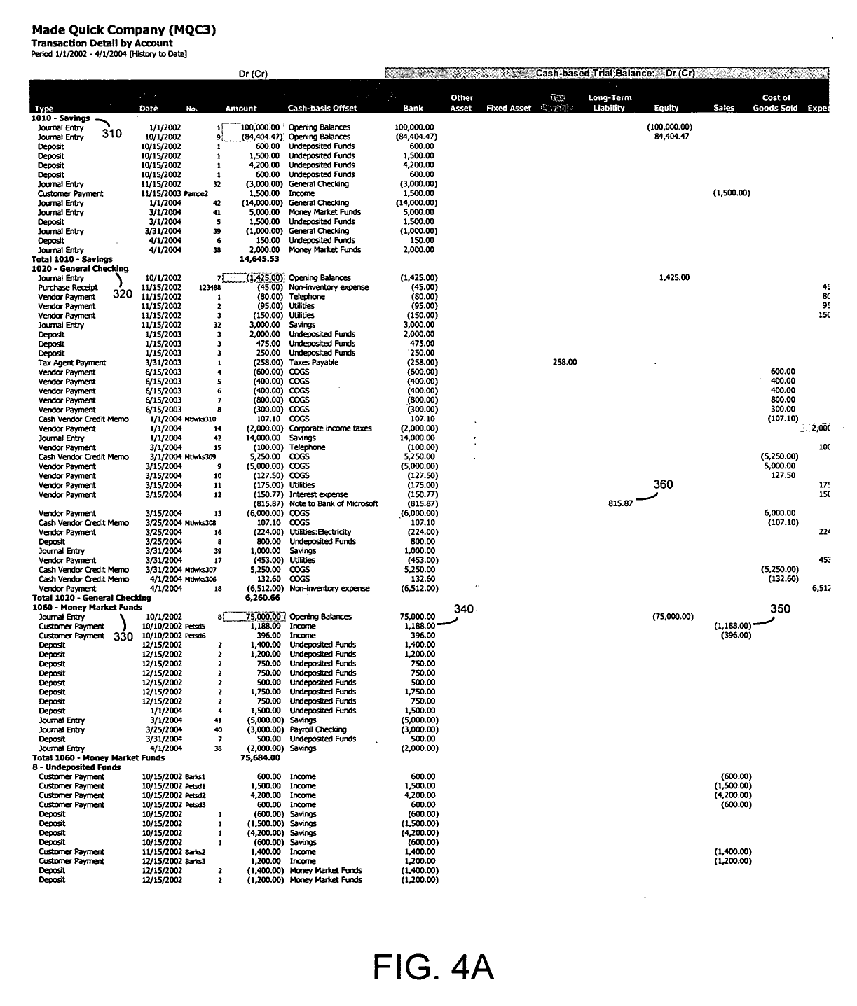

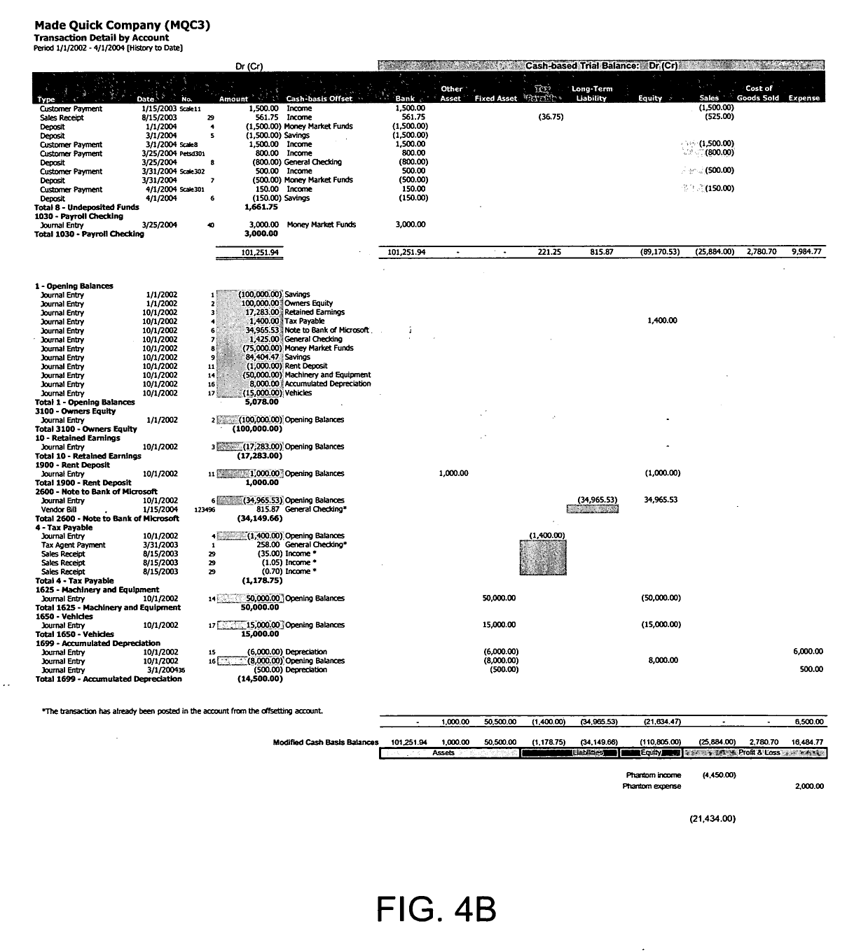

FIG. 2 illustrates a method of automatically switching from an accrual basis to a cash flow basis for accounting. At block 200, an entry in the general ledger is reviewed. For example, FIGS. 4A and 4B are illustrations of a general ledger. A general ledger has a series of accounts, for example, in FIG. 4A, account 310 is a savings account, numeral 320 represents general checking related general ledger entries, numeral 330 represents money market funds, etc. Each transactional entry should have an equal debit and credit entry.

At block 210, the method may determine whether the entry in the general ledger is for a transaction between general ledger accounts that are treated differently in accrual basis accounting and cash basis accounting. For example, in FIG. 4A, under heading 1060 Money Market Funds, identification number 330, customer payment identification number 340 in the amount of $1,188.00 normally would be an accrual but is offset in cash basis accounting 350. Accordingly, this entry is identified as an entry for transaction that involves an accrual.

3 illustrates a grid that indicates which general ledger account type postings may be reviewed. Column 270 lists account types, row 272 list offseting account types and the intersection of the types indicates which posting between the accounts are to be reviewed. For example, if there is a posting between the credit card account 274 and the bank account 276, then the “y” in the block 278 where the credit card account 274 and bank account 276 intersect indicates that postings between these accounts are to be reviewed. Continuing to review the credit card account 274, at the intersection of the credit card row 274 and the inventory asset column 280, lack of a “y” and/or the presence of a grey block at intersection 282 may indicate that postings between these accounts will not be reviewed because transactions between these accounts would not be changed when switching from an accrual basis to a cash flow basis. In general, the following lists some examples of the different treatment of accounts in cash basis systems and in accrual basis systems:

Accounts Payable. Cash Basis: Unpaid bills are not part of the accounting system. Accrual Basis: Unpaid bills are expensed, whether or not the purchaser has physically paid for the goods in question.

Depreciation. Cash Basis: When fixtures or equipment are purchased, the purchaser pays cash and the item is expensed immediately. Accrual Basis: Purchases of major assets are expensed over their useful lives, perhaps on a three- or five-year schedule.

Inventory. Cash Basis: When inventory is purchased, it is booked as expense. Accrual Basis: Inventory is booked as an asset and inventory is only charged as an expense when the inventory items are actually used.

Prepaid Expense. Cash Basis: Bills paid in advance are treated as a simple expense. Accrual Basis: Advance payments are “held” as liabilities on the balance sheet and when the goods or services are received, the “real” expense is recorded.

Prepaid Revenue. Cash Basis: If a customer pays in advance or furnishes a deposit, it is simply treated as a current receipt. Accrual Basis: Advance payments are treated as prepaid revenue and they are recorded as “real” revenue when the goods or services are actually furnished to the customer.

Receivables. Under the cash basis, income is recognized when it is received. Under the accrual basis, income is recognized when it's earned, whether the cash is received or not.

Work in Progress. Cash Basis: The value of work in progress is ignored. Accrual Basis: Work in progress is recorded as an asset at the end of accounting periods.

It should be noted that the current system works at an even lower level by examining the specific postings between accounts and not just looking at broad totals in accounts. If at block 210 that the entry does not involving entries that need to be modified, the method may continue to block 240 and the balance sheet and income statement may not differ between the accrual and cash basis accounting basis.

If block 210 determines that the entry involves a transaction between accounts that are treated differently in cash basis accounting and accrual basis accounting then, at block 220, a modifying entry to convert the entry to cash basis is determine. For example, looking at FIG. 4A, the customer payment that has not been received for $1,188.00 (identified by number 350) then is modified based on the amount that has not yet been received, which in this case $0.00 has been received, so the entire entry is reversed. If 20% of the payment had been received, then 20% of the entry would be reversed. As another example, referring to the note payable to the Bank of Microsoft, number 360, as this entire amount of $815.87 has not been paid, the entire amount is reversed. If 20% of the payable had been paid, then 20% of the entry would have been reversed. Control may then pass to block 230.

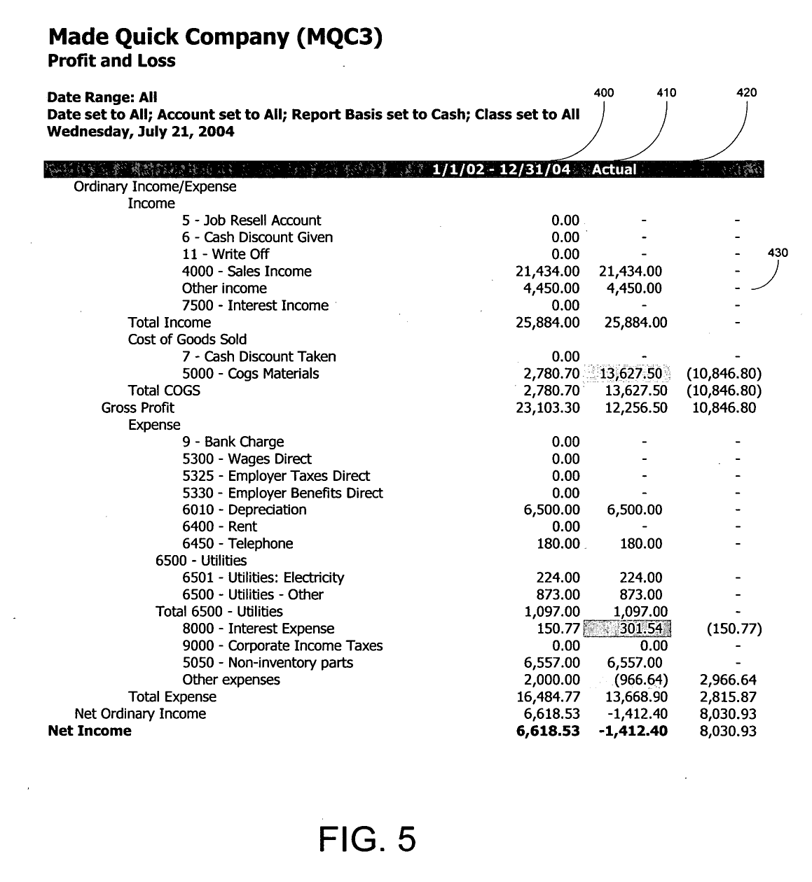

At block 230, the original accrual entry is modified such that it will now be proper under cash basis accounting. The modification can be a separate entry or the original entry may be temporarily modified. At block 240, a modified balance sheet and modified income statement based on the reversed payable and accrual entries may be created. Referring to FIG. 5, a profit and loss statement is illustrated which indicates the changes made by the method. The first numbered column 400 indicates the status of the accounts using the cash basis accounting system and the second column 410 list the account status using the accrual method of accounting and the third column 420 illustrates the changes made by the system while changing from the accrual method of accounting to the cash method of accounting.

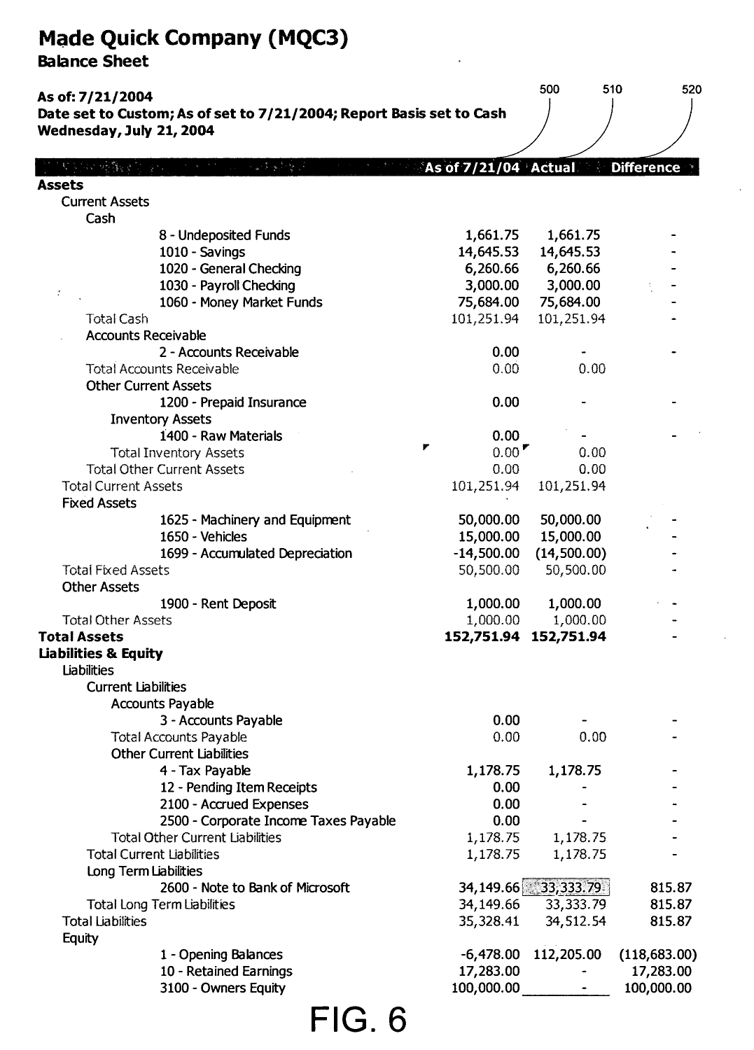

Referring to FIG. 6, a balance sheet is illustrated which describes the balance sheet of Made Quick Company. The first numeric column 500, lists the status of the balance sheet accounts using the cash basis of accounting. The second column 510 lists the status of the accounts using the accrual method of accounting. The third column 520 illustrates the differences to the various accounts when switching from the accrual method of accounting to the cash basis method of accounting using the method described.

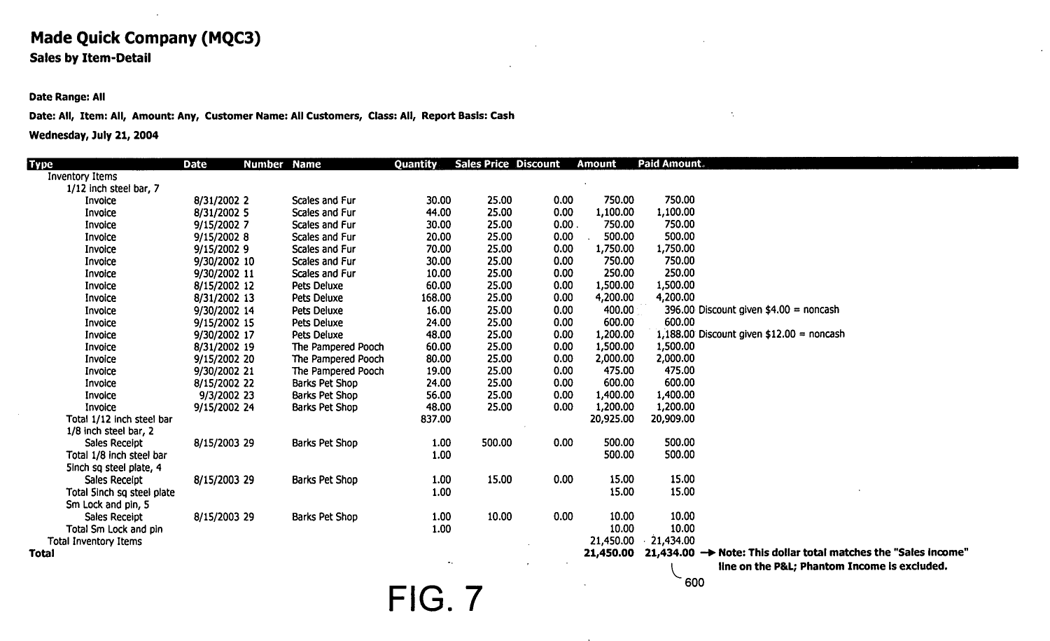

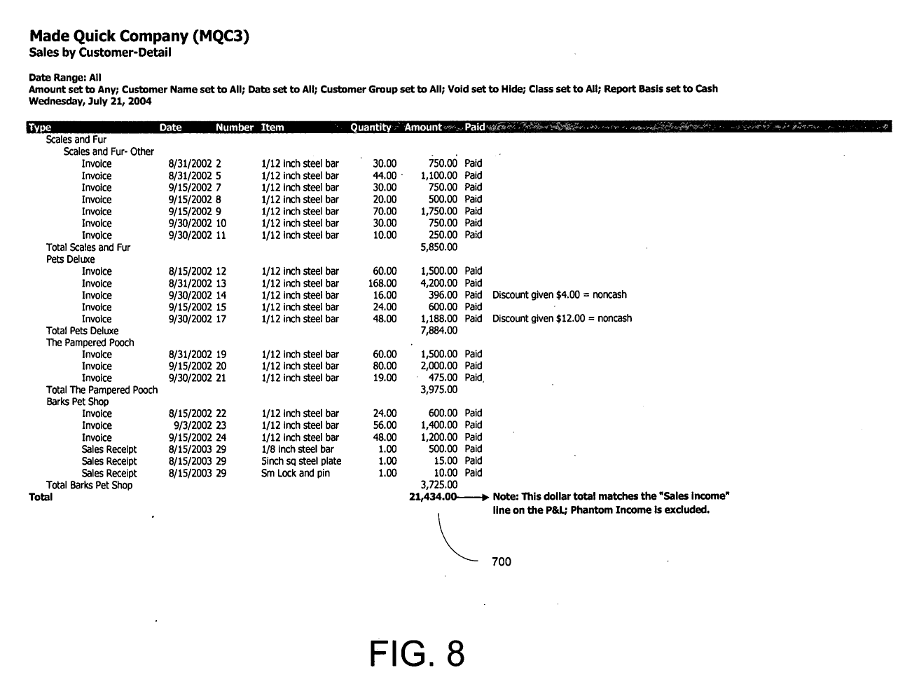

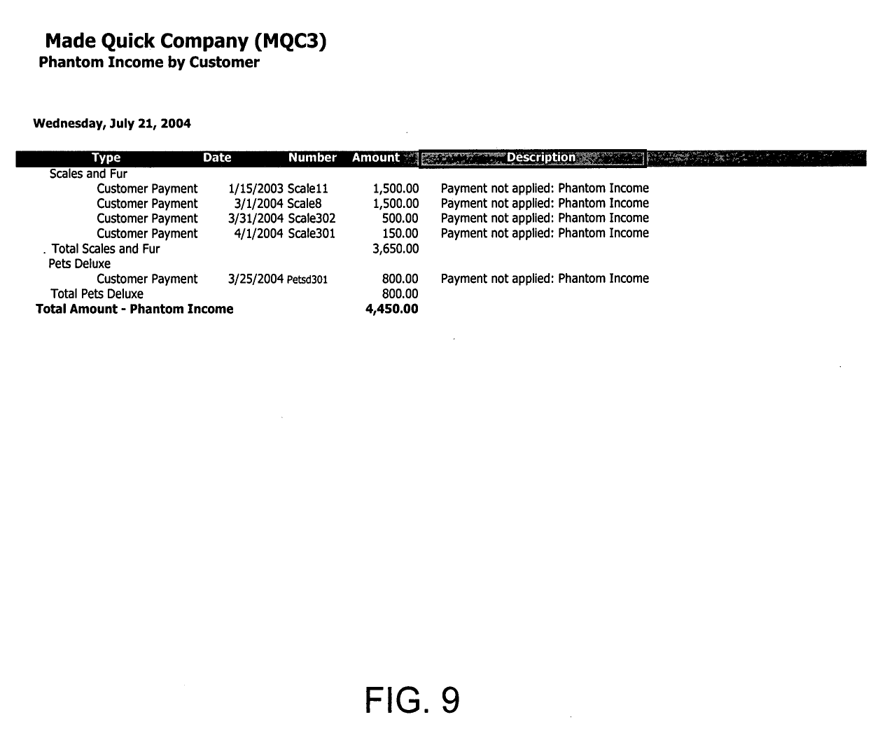

The method also allows for the reversal of payables and receivables when either an entire amount has yet to be received or an entire amount has yet to be paid, or when the amount of payment or the amount of payable has not been identified as relating to a specific sale or to a specific purchase. For example, if a customer made a payment without specifying what invoice the payment related to, the payment may not have been applied to any invoice. The system will keep the income as phantom income and it would be displayed on a profit and loss statement as other income. For example, FIG. 7 illustrates a sales by item detail for Made Quick Company. Total amount paid 600 is listed as $21,434.00. Similarly, FIG. 8 illustrates a Sales by Customer-Detail for Made Quick Company and also lists the amount of sales 700 as being $21,434.00. However, FIG. 9 illustrates five payments were made which were not applied because they did not indicate a specific invoice to which they were scheduled to be applied. However, the money was actually received and needs to be recognized on the profit and loss statement. Accordingly, referring to FIG. 5, the $4,450.00 which was received is listed as being Phantom Income on FIGS. 7, 8 and 9 and is disclosed as “Other Income” at entry 430. This is just one example of the operation of the proposed system.

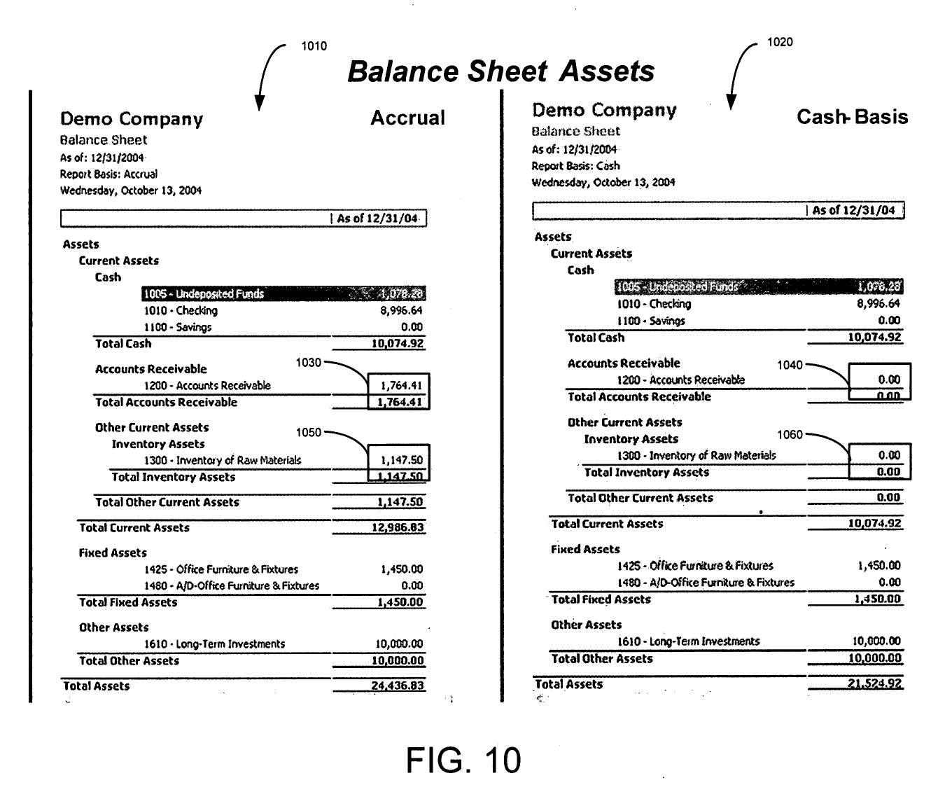

FIGS. 10, 11 and 12 illustrate another example of the system. FIG. 10 illustrates a display of a balance sheet using both accrual basis accounting and cash basis accounting. The accrual basis balance sheet is numbered as 1010 and the cash basis balance sheet is numbered as 1020. Under the accounts receivable heading, the difference between the statements may be seen. For example, viewing the accrual method statement 1010, the accounts receivable 1030 are listed as $1,764.41. This amount may relates to sale that have been made but where the money has not been collected for these sales. In the cash basis balance sheet 1020, the accounts receivable amount 1040 is listed as being $0.00 which is correct because on a cash basis, only items where cash is actually received or actually paid is recognized. Similarly, viewing the accrual method statement 1010, the inventory of raw materials amount 1050 is listed as $1147.50 and viewing the cash basis statement 1020, the inventory of raw materials amount 1060 is listed as $0.00. This makes sense as in the cash basis statement, when inventory is purchased, the inventory is only booked as an expense. Using the accrual basis, inventory is booked as an asset and inventory items are only charged to expense when they're actually used.

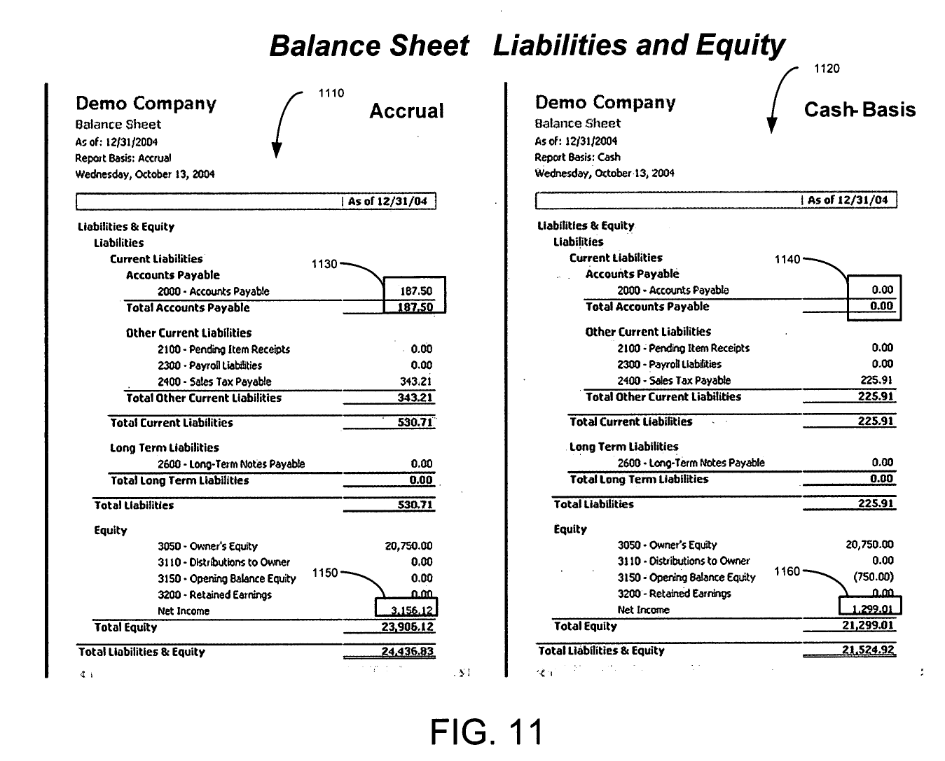

Viewing FIG. 11, the balance sheet from FIG. 10 is continued, and FIG. 11 lists the Liabilities and Equities. Viewing the accrual method statement 1110, the accounts payable entry 1130 is listed as being $187.50. On the cash basis statement 1120, the accounts payable amount 1140 is listed as $0.00. This makes sense because under the cash basis, unpaid bills are not part of the accounting system where in the accrual basis, unpaid bills are expensed, whether or not physically payment for the goods in question has been made. As a result of the changes, the reported net income on the cash basis statement 1160 is $1,299.01 and the reported net income on the accrual statement 1150 is $3,156.12.

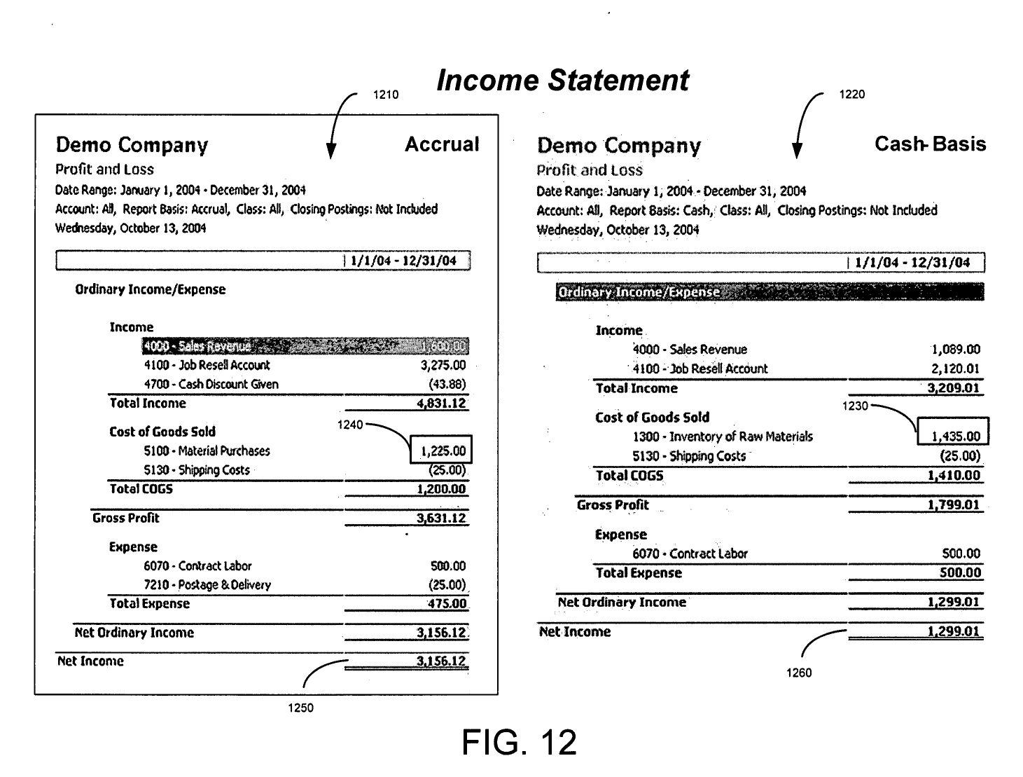

Similar changes can be seen in FIG. 12, which is an income statement computed using both the accrual basis 1210 and the cash basis 1220. An example of the changes between the accrual income statement 1210 and the cash basis income statement 1220 is in the cost of goods sold section. In the cash basis statement 1120, inventory is booked as an expense and shows up in account 1300—Inventory of Raw Materials 1230 in the amount of $1,435.00. In the accrual statement 1210, only the materials used are charges as an expense as illustrated by account 5100—Material Purchases 1240 in the amount of $1,225.00.

Finally, the changes from the accrual based system to the cash based system appear in the reported net income. In the accrual statement 1210, net income is listed 1250 as $3,156.12 and in the cash statement 1220, net income is listed 1260 as $1,229.01, thereby illustrating the potential for net income to be modified by switching the accounting basis for a business.

1. A method of automatically converting from accrual based accounting to cash basis accounting using a computer comprising:
Reviewing an entry in a general ledger;
Determining whether the entry in the general ledger is for a transaction between general ledger accounts that are treated differently in accrual based accounting and cash basis accounting;
For an entry determined to be between general ledger accounts that are treated differently in accrual based accounting and cash basis accounting, determining a modifying entry to the entry to convert the entry from accrual basis accounting to cash basis accounting;
For the entries determined to be between general ledger accounts that are treated differently in accrual based accounting and cash basis accounting, modifying the amount of the entry based on the determined modified entry; and
Creating a modified balance sheet and modified income statement based on the modified entry.

2. The method of claim 1, further comprising:
Modifying the amount of the entry based on the percentage of a payment that has been received.

3. The method of claim 1, further comprising:
Modifying the amount of the entry based on the percentage of the payment that has been made.

4. The method of claim 1, further comprising: creating a table of the entries that were modified.

5. The method of claim 1, further comprising:
placing in a phantom income account payments from customers that have not yet been applied to an invoice such that the payments are included in the modified balance sheet and modified income statement.

6. The method of claim 1, further comprising:
placing in a phantom expense account payments to vendors that have not yet been applied to a bill such that the expenses are included in the modified balance sheet and modified income statement.

7. The method of claim 1 further comprising:
displaying in the sales tax payable account the opening balance, sales tax paid on paid or partially paid invoices and payments to tax vendors so long as the amounts had at least one posting to a cash or bank account.

8. The method of claim 1, further comprising:
allowing a user to select, using a drop down selection box, to view financial statements as one of cash basis statements and accrual basis statements.

9. The method of claim 1, further comprising:
allowing a user to select, using a drop down selection box, to view financial statements as one of cash basis statements and accrual basis statements and allowing the user to switch between the cash basis statements and the accrual basis statements.

10. The method of claim 1, further comprising:
allowing a user to create a statement that highlights the differences between cash basis accounting and accrual based accounting for a particular entity.

11. The method of claim 1, further comprising:
allowing a user to view financial statements as one of cash basis statements and accrual basis statements and allowing the user to switch between the cash basis statements and the accrual basis statements by storing the calculated changes in a temporary location without modifying the underlying entries.

12. A memory having a computer program stored therein, said computer program being capable of being used in connection with a computing apparatus, said memory comprising:
a memory portion physically configured in accordance with computer program instructions that would cause the computing apparatus to review an entry in a general ledger;
a memory portion physically configured in accordance with computer program instructions that would cause the computing apparatus to determine whether the entry in the general ledger is for a transaction between general ledger accounts that are treated differently in accrual based accounting and cash basis accounting;
a memory portion physically configured in accordance with computer program instructions that would cause the computing apparatus to, for an entry determined to be between general ledger accounts that are treated differently in accrual based accounting and cash basis accounting, determine a modifying entry to the entry to convert the entry from accrual basis accounting to cash basis accounting;
a memory portion physically configured in accordance with computer program instructions that would cause the computing apparatus to, for the entries determined to be between general ledger accounts that are treated differently in accrual based accounting and cash basis accounting, modifying the amount of the entry based on the determined modified entry; and;
a memory portion physically configured in accordance with computer program instructions that would cause the computing apparatus to create a modified balance sheet and modified income statement based on the modified entry.

13. The memory of claim 12, further comprising:
a further memory portion physically configured in accordance with computer program instructions that would cause the computing apparatus to modify the amount of the entry based on the percentage of a payment that has been received.

14. The memory of claim 12, further comprising:
a further memory portion physically configured in accordance with computer program instructions that would cause the computing apparatus to modify the amount of the entry based on the percentage of the payment that has been made.

15. The memory of claim 12, further comprising:
a further memory portion physically configured in accordance with computer program instructions that would cause the computing apparatus to create a table of the entries that were modified.

16. The memory of claim 12, further comprising:
a further memory portion physically configured in accordance with computer program instructions that would cause the computing apparatus to place in a phantom income account payments from customers that have not yet been applied to an invoice such that the payments are included in the modified balance sheet and modified income statement.

17. The memory of claim 12, further comprising:
a further memory portion physically configured in accordance with computer program instructions that would cause the computing apparatus to place in a phantom expense account payments to vendors that have not yet been applied to a bill such that the expenses are included in the modified balance sheet and modified income statement.

18. The memory of claim 12 further comprising:
a further memory portion physically configured in accordance with computer program instructions that would cause the computing apparatus to display in the sales tax payable account the opening balance, sales tax paid on paid or partially paid invoices and payments to tax vendors so long as the amounts had at least one posting to a cash or bank account.

19. The memory of claim 12, further comprising:
a further memory portion physically configured in accordance with computer program instructions that would cause the computing apparatus to allow a user to select, using a drop down selection box, to view financial statements as one of cash basis statements and accrual basis statements.

20. The memory of claim 12, further comprising:
a further memory portion physically configured in accordance with computer program instructions that would cause the computing apparatus to allow a user to select, using a drop down selection box, to view financial statements as one of cash basis statements and accrual basis statements and allowing the user to switch between the cash basis statements and the accrual basis statements.

21. The memory of claim 12, further comprising:
a further memory portion physically configured in accordance with computer program instructions that would cause the computing apparatus to allow a user to create a statement that highlights the differences between cash basis accounting and accrual based accounting for a particular entity.

22. The memory of claim 12, further comprising:
a further memory portion physically configured in accordance with computer program instructions that would cause the computing apparatus to allow a user to view financial statements as one of cash basis statements and accrual basis statements and allowing the user to switch between the cash basis statements and the accrual basis statements by storing the calculated changes in a temporary location without modifying the underlying entries.

23. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to review an entry in a general ledger;
said processing apparatus being programmed to determine whether the entry in the general ledger is for a transaction between general ledger accounts that are treated differently in accrual based accounting and cash basis accounting;
said processing apparatus being programmed to, for an entry determined to be between general ledger accounts that are treated differently in accrual based accounting and cash basis accounting, determine a modifying entry to the entry to convert the entry from accrual basis accounting to cash basis accounting;
said processing apparatus being programmed, for the entries determined to be between general ledger accounts that are treated differently in accrual based accounting and cash basis accounting, modifying the amount of the entry based on the determined modified entry; and;
said processing apparatus being programmed to create a modified balance sheet and modified income statement based on the modified entry.

24. The computing apparatus of claim 23, further comprising:
said processing apparatus being programmed to modify the amount of the entry based on the percentage of a payment that has been received.

25. The computing apparatus of claim 23, further comprising:
said processing apparatus being programmed to modify the amount of the entry based on the percentage of the payment that has been made.

26. The computing apparatus of claim 23, further comprising:
said processing apparatus being programmed to creating a table of the entries that were modified.

27. The computing apparatus of claim 23, further comprising:
said processing apparatus being programmed to place in a phantom income account payments from customers that have not yet been applied to an invoice such that the payments are included in the modified balance sheet and modified income statement.

28. The computing apparatus of claim 23, further comprising:
said processing apparatus being programmed to place in a phantom expense account payments to vendors that have not yet been applied to a bill such that the expenses are included in the modified balance sheet and modified income statement.

29. The computing apparatus of claim 23, further comprising:
said processing apparatus being programmed to display in the sales tax payable account the opening balance, sales tax paid on paid or partially paid invoices and payments to tax vendors so long as the amounts had at least one posting to a cash or bank account.

30. The computing apparatus of claim 23, further comprising:
said processing apparatus being programmed to allow a user to select, using a drop down selection box, to view financial statements as one of cash basis statements and accrual basis statements.

31. The computing apparatus of claim 23, further comprising:
said processing apparatus being programmed to allow a user to select, using a drop down selection box, to view financial statements as one of cash basis statements and accrual basis statements and allowing the user to switch between the cash basis statements and the accrual basis statements.

32. The computing apparatus of claim 23, further comprising:
said processing apparatus being programmed to allow a user to create a statement that highlights the differences between cash basis accounting and accrual based accounting for a particular entity.

33. The computing apparatus of claim 23, further comprising:
said processing apparatus being programmed to allow a user to view financial statements as one of cash basis statements and accrual basis statements and allowing the user to switch between the cash basis statements and the accrual basis statements by storing the calculated changes in a temporary location without modifying the underlying entries.
